(19) United States
(12) Patent Application Publication
(10) Pub. No.: US 2019/0050906 A1
(43) Pub. Date: Feb. 14, 2019

(54) DIGITAL SIGNAGE CONTROL DEVICE, DIGITAL SIGNAGE CONTROL METHOD, AND NON-TRANSITORY STORAGE MEDIUM STORING PROGRAM

(71) Applicants: TOYOTA JIDOSHA KABUSHIKI KAISHA, Toyota-shi (JP); TOYOTA Connected Corporation, Nagoya-shi (JP)

(72) Inventors: Masakazu NOMURA, Nagoya-shi (JP); Masato ENDO, Nagakute-shi (JP); Naoki YAMAMURO, Nagoya-shi (JP)

(73) Assignees: TOYOTA JIDOSHA KABUSHIKI KAISHA, Toyota-shi (JP); TOYOTA Connected Corporation, Nagoya-shi (JP)

(21) Appl. No.: 16/055,687

(22) Filed: Aug. 6, 2018

(30) Foreign Application Priority Data
Aug. 8, 2017 (JP) 2017-152976

(51) Int. Cl. G06Q 30/02; G01S 19/03

(52) U.S. Cl. CPC G06Q 30/0266; G06Q 30/0272; G01S 19/03

(57) ABSTRACT

A digital signage control device includes: a display controller configured to display predetermined information on a digital signage disposed around a predetermined road; a target vehicle detector configured to detect a vehicle located in a predetermined range on the road; and a work load information acquisition unit configured to acquire work load information regarding a work load state of an occupant of the vehicle. The predetermined range on the road is a range in which the occupant of the vehicle visually recognizes the digital signage. The display controller changes the amount of predetermined information to be displayed on the digital signage according to the work load information.

### INCORPORATION BY REFERENCE

The disclosure of Japanese Patent Application No. 2017-152976 filed on Aug. 8, 2017 including the specification, drawings and abstract is incorporated herein by reference in its entirety.

### BACKGROUND

### 1. Technical Field

The present invention relates to a digital signage control device, a digital signage control method, and a non-transitory storage medium storing a program.

### 2. Description of Related Art

A digital signage for occupants of vehicles including drivers riding in the vehicles is known (for example, refer to US 2016/0180709A).

### SUMMARY

However, in a case where the work load of an occupant of each vehicle becomes relatively high for some reason, there is a possibility that the occupant of the vehicle may not be able to sufficiently grasp the content of information displayed on the digital signage in a time during which the digital signage can be visually recognized from the traveling vehicle. For example, in a case where a work load for driving operation (hereinafter, referred to as a “driving load”) becomes higher than a driving load threshold value, the driver may not have time to sufficiently check the digital signage. For example, in a case where it is relatively difficult for the occupant to see the content of the digital signage depending on the positional relationship between the digital signage and the vehicle and accordingly the work load itself for visually recognizing the digital signage (hereinafter, referred to as “visual recognition work load”) increases, the occupant may not be able to sufficiently grasp the content of the digital signage.

The invention provides a digital signage control device, a digital signage control method, and a non-transitory storage medium storing a program that make it possible for an occupant of a vehicle to more reliably grasp the content of information displayed on a digital signage even in a case where the work load of the occupant of the vehicle is relatively high.

A first aspect of the invention relates to a digital signage control device including circuitry. The circuitry is configured to display predetermined information on a digital signage disposed around a predetermined road. The circuitry is configured to detect a vehicle located in a predetermined range on the road. The circuitry is configured to acquire work load information regarding a work load state of the occupant of the vehicle. The predetermined range on the road is a range in which the occupant of the vehicle visually recognizes the digital signage. The circuitry is configured to change an amount of the predetermined information to be displayed on the digital signage according to the work load information.

According to the first aspect of the invention, the display controller can change the amount of information displayed on the digital signage according to the work load state of the occupant of the vehicle. Therefore, for example, in a case where determination that the work load of the occupant is relatively high for some reason can be made, it is possible to relatively reduce the amount of information displayed on the digital signage. As a result, even in a situation in which it is difficult for the occupant to grasp the information displayed on the digital signage, the occupant of the vehicle can more reliably grasp the content of the information displayed on the digital signage.

In the digital signage control device according to the first aspect of the invention, the circuitry may be configured to acquire the work load information including at least one of information regarding a driving load of a driver of the vehicle and information regarding a visual recognition work load for the occupant of the vehicle to visually recognize the digital signage.

According to the first aspect of the invention, by using the information regarding the driving load of the driver or the information regarding the visual recognition work load of the occupant as the work load information, specifically, according to the situation of the driving load or the visual recognition work load, the display controller can change the amount of information displayed on the digital signage.

In the digital signage control device according to the first aspect of the invention, the circuitry may be configured to set, when the driving load is higher than a driving load threshold value, the amount of the predetermined information displayed on the digital signage to be less than the amount of the predetermined information displayed on the digital signage when the driving load is lower than the driving load threshold value.

According to the first aspect of the invention, in a situation in which the driving load of the driver is higher than the driving load threshold value and accordingly it is difficult for the driver to grasp the information displayed on the digital signage, the amount of displayed information is relatively reduced. Therefore, even in the above-described situation, the driver of the vehicle can more reliably grasp the content of the information displayed on the digital signage.

In the digital signage control device according to the first aspect of the invention, the information regarding the driving load may include information regarding an automatic driving level of the vehicle. The circuitry may be configured to set, when the automatic driving level is lower than an automatic driving level threshold value, the amount of the predetermined information displayed on the digital signage to be less than the amount of the predetermined information displayed on the digital signage when the automatic driving level is higher than the automatic driving level threshold value.

According to the first aspect of the invention, in a situation in which the automatic driving level of the vehicle is lower than the automatic driving level threshold value and accordingly the driving load of the driver is higher than the driving load threshold value and it is difficult for the driver to grasp the information displayed on the digital signage, the amount of displayed information is relatively reduced. Therefore, even in the above-described situation, the driver of the vehicle can more reliably grasp the content of the information displayed on the digital signage.

In the digital signage control device according to the first aspect of the invention, the circuitry is configured to set, when the visual recognition work load is higher than a visual recognition work load threshold value, the amount of the predetermined information displayed on the digital signage to be less than the amount of the predetermined information displayed on the digital signage the visual recognition work load is lower than the visual recognition work load threshold value.

According to the first aspect of the invention, for example, in a situation in which the visual recognition work load for the occupant of the vehicle to visually recognize the digital signage is higher than the visual recognition work load threshold value, such as in the digital signage provided on a curved road, the amount of information displayed on the digital signage is relatively reduced. Therefore, even in the above-described situation, the occupant of the vehicle can more reliably grasp the content of the information displayed on the digital signage.

In the digital signage control device according to the first aspect of the invention, the information regarding the visual recognition work load may include information regarding a distance between the vehicle and the digital signage. The circuitry may be configured to set, when the distance is longer than a distance threshold value, the amount of the predetermined information displayed on the digital signage to be less than the amount of the predetermined information displayed on the digital signage the distance is shorter than the distance threshold value.

According to the first aspect of the invention, in a situation in which the distance between the vehicle and the digital signage is longer than the distance threshold value and accordingly the visual recognition work load for the occupant of the vehicle to visually recognize the digital signage is higher than the visual recognition work load threshold value, the amount of displayed information is relatively reduced. Therefore, even in the above-described situation, the occupant of the vehicle can more reliably grasp the content of the information displayed on the digital signage.

In the digital signage control device according to the first aspect of the invention, the information regarding the driving load and the information regarding the visual recognition work load may include information regarding a vehicle speed of the vehicle. The circuitry may be configured to set, when the vehicle speed is higher than a vehicle speed threshold value, the amount of the predetermined information displayed on the digital signage to be less than that in a case where the vehicle speed is lower than the vehicle speed threshold value.

According to the first aspect of the invention, in a case where the vehicle speed becomes higher than the vehicle speed threshold value, acceleration of various determinations in the driving operation is demanded, and the driving load becomes higher than the driving load threshold value. In a case where the vehicle speed becomes higher than the vehicle speed threshold value, a higher dynamic vision for checking the information of the digital signage is demanded, and the visual recognition work load becomes higher than the visual recognition work load threshold value. As a result, in the above-described situation, the amount of displayed information is relatively reduced. Therefore, even in the above-described situation, occupants including the driver of the vehicle can more reliably grasp the content of the information displayed on the digital signage.

In the digital signage control device according to the first aspect of the invention, the circuitry may be configured to change the amount of the predetermined information displayed on the digital signage by changing the number of pieces of detailed information actually included in a content of the predetermined information among a plurality of pieces of detailed information included as the content of the predetermined information.

According to the first aspect of the invention, for example, in the case of displaying the advertisement information of a product on the digital signage, the display controller can change the amount of information by changing a combination of a plurality of pieces of detailed information, such as a brand name of a product, a catchphrase, and a product photograph that can configure advertisement information.

In the digital signage control device according to the first aspect of the invention, the circuitry may be configured to determine detailed information actually included in the content of the predetermined information, among the pieces of detailed information, according to a priority defined in advance for each of the plurality of pieces of detailed information.

According to the first aspect of the invention, by adopting a method in which detailed information having a relatively high priority is included in information that is preferentially displayed according to the priority defined in advance, the display controller can change the amount of information. For example, by giving a relatively high priority in advance to detailed information having a relatively high contribution to grasping the information displayed on the digital signage by the occupant of the vehicle, the occupant of the vehicle can more reliably grasp the content of the information displayed on the digital signage.

A second aspect of the invention relates to a digital signage control method including: displaying predetermined information on a digital signage disposed around a predetermined road; detecting a vehicle located in a predetermined range on the road; and acquiring work load information regarding a work load state of the occupant of the vehicle. The predetermined range on the road is a range in which the occupant of the vehicle visually recognizes the digital signage. The displaying of the predetermined information includes changing an amount of the predetermined information to be displayed on the digital signage according to the work load information.

A third aspect of the invention relates to a non-transitory storage medium storing a program. The program causes a computer to execute: a display control step of displaying predetermined information on a digital signage disposed around a predetermined road; a target vehicle detection step of detecting a vehicle located in a predetermined range on the road; and a work load information acquisition step of acquiring work load information regarding a work load state of the occupant of the vehicle. The predetermined range on the road is a range in which the occupant of the vehicle visually recognizes the digital signage. In the display control step, an amount of the predetermined information to be displayed on the digital signage is changed according to the work load information.

According to the aspects of the invention, it is possible to provide a digital signage control device, a digital signage control method, and a non-transitory storage medium storing a program that make it possible for an occupant of a vehicle to more reliably grasp the content of information displayed on a digital signage even in a case where the work load of the occupant of the vehicle is relatively high.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram schematically showing an example of the configuration of an advertisement distribution system;

FIG. 2 is a functional block diagram schematically showing an example of the functional configuration of a vehicle (master ECU);

FIG. 3 is a functional block diagram schematically showing an example of the functional configuration of a movement information management server (processing apparatus);

FIG. 4 is a functional block diagram schematically showing an example of the functional configuration of an advertisement management server (processing apparatus);

FIG. 5 is a diagram showing an example of a plurality of pieces of detailed information configuring advertisement information;

FIG. 6 is a diagram showing another example of a plurality of pieces of detailed information configuring advertisement information;

FIG. 7 is a flowchart schematically showing a first example of information amount change processing of an advertisement management server;

FIG. 8 is a flowchart schematically showing a second example of the information amount change processing of the advertisement management server;

FIG. 9 is a flowchart schematically showing a third example of the information amount change processing of the advertisement management server; and

FIG. 10 is a flowchart schematically showing a fourth example of the information amount change processing of the advertisement management server.

### DETAILED DESCRIPTION OF EMBODIMENTS

Hereinafter, embodiments for carrying out the invention will be described with reference to the diagrams.

### Configuration of Advertisement Distribution System

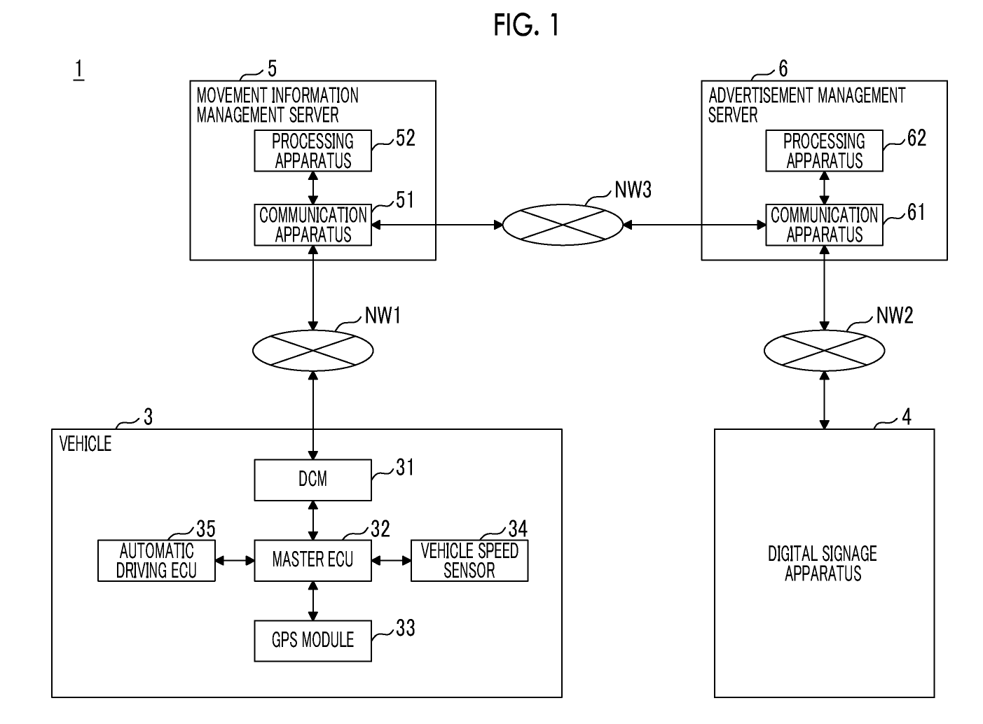

First, the configuration of an advertisement distribution system 1 according to the present embodiment will be described with reference to FIGS. 1 to 4.

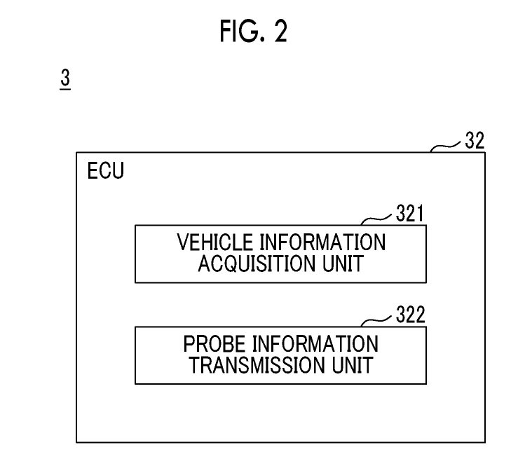

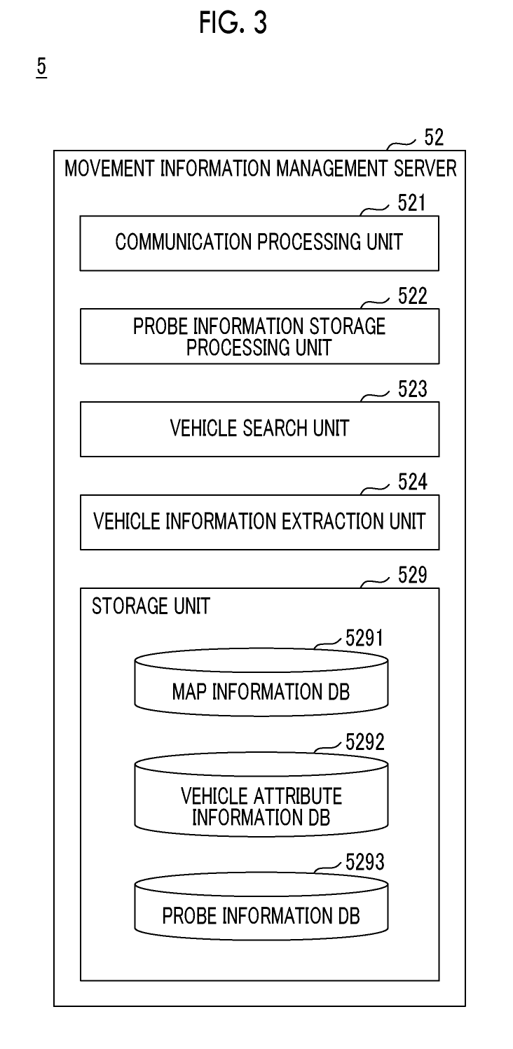

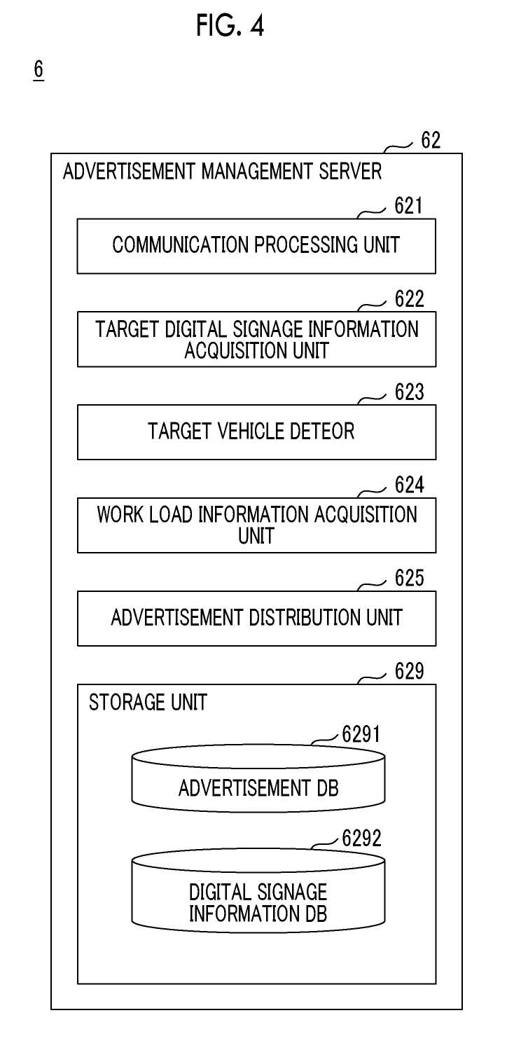

FIG. 1 is a diagram schematically showing the configuration of the advertisement distribution system 1 according to the present embodiment. FIG. 2 is a functional block diagram schematically showing an example of the functional configuration of a vehicle 3 (master ECU 32) according to the present embodiment. FIG. 3 is a functional block diagram schematically showing an example of the functional configuration of a movement information management server 5 (processing apparatus 52). FIG. 4 is a functional block diagram schematically showing an example of the functional configuration of an advertisement management server 6 (processing apparatus 62) according to the present embodiment.

The advertisement distribution system 1 includes: a plurality of vehicles 3; a plurality of digital signage apparatuses 4 installed around a certain road, for example, in a roadside range of the road or immediately above the road; the movement information management server 5 communicably connected to the vehicles 3; and the advertisement management server 6 communicably connected to the digital signage apparatuses 4 and the movement information management server 5. As will be described in detail later, the advertisement distribution system 1 distributes advertisement information for occupants of the vehicle 3, which is located on a road adjacent to the installation position of the digital signage apparatus 4, to the digital signage apparatus 4.

Since the configurations of the vehicles 3 relevant to the advertisement distribution system 1 are approximately the same, one vehicle 3 is representatively shown in diagrams. Since the configurations of the digital signage apparatuses 4 relevant to the advertisement distribution system 1 are approximately the same, one digital signage apparatus 4 is representatively shown in diagrams.

The vehicle 3 includes a data communication module (DCM) 31, a master electronic control unit (ECU) 32, a global positioning system (GPS) module 33, a vehicle speed sensor 34, and an automatic driving ECU 35.

The DCM 31 is a communication device that performs bidirectional communication with the movement information management server 5 through a predetermined communication network NW1 (for example, a mobile phone network terminating at a plurality of base stations or an Internet network; hereinafter, the same applies to communication networks NW2 and NW3). The DCM 31 is communicably connected to various ECUs including the master ECU 32 and the automatic driving ECU 35 through an in-vehicle network, such as a controller area network (CAN).

The master ECU 32 is an electronic control unit that performs various kinds of control processing relevant to predetermined functions in a vehicle 3. For example, the master ECU 32 acquires various kinds of information (vehicle information) regarding the vehicle state of the vehicle 3, the state of an occupant, and the like, and performs processing for uploading the various kinds of information (vehicle information) to the movement information management server 5 as probe information through the DCM 31. The function of the master ECU 32 may be realized by any software, any hardware, or a combination of any hardware and any software. For example, the master ECU 32 may be mainly formed of a microcomputer including a central processing unit (CPU), a random access memory (RAM), a read only memory (ROM), an auxiliary storage device, and an input/output (I/O) interface. Hereinafter, the same applies to the automatic driving ECU 35 to be described later. The master ECU 32 includes, for example, a vehicle information acquisition unit 321 and a probe information transmission unit 322 as functional units realized by executing one or more programs stored in the ROM or the auxiliary storage device on the CPU.

Some functions of the master ECU 32 may be shared by one or a plurality of other ECUs.

The vehicle information acquisition unit 321 acquires vehicle information, which is input from the GPS module 33, the vehicle speed sensor 34, the automatic driving ECU 35, and the like, from a buffer in the RAM or the like. Specifically, the vehicle information acquisition unit 321 acquires the position information of the vehicle 3 input from the GPS module 33. The vehicle information acquisition unit 321 acquires information regarding the vehicle speed of the vehicle 3 (vehicle speed information) input from the vehicle speed sensor 34. The vehicle information acquisition unit 321 acquires information regarding the operating state of the automatic driving function (automatic driving information) input from the automatic driving ECU 35.

The automatic driving function includes various driving assistance functions corresponding to automatic driving level 2 among the automatic driving levels defined by the national highway traffic safety administration (NHTSA) or society of automotive engineers (SAE). The various driving assistance functions include, for example, driving assistance functions relevant to acceleration, steering, and braking, such as adaptive cruise control (ACC), pre-crash safety (PCS), and lane keeping assist (LKA). The automatic driving information includes information regarding whether or not the automatic driving function is operating. The automatic driving information includes information regarding whether or not one of the various driving assistance functions corresponding to automatic driving level 2 among the automatic driving levels defined by NHTSA or SAE is operating. The automatic driving information includes information regarding which automatic driving level is selected in a case where the vehicle 3 is configured to be able to select a plurality of automatic driving levels among the automatic driving levels defined by NHTSA or SAE.

The probe information transmission unit 322 generates various kinds of vehicle information acquired by the vehicle information acquisition unit 321 and probe information, which includes time information corresponding to the various kinds of vehicle information, at predetermined periods, and transmits the various kinds of vehicle information and the probe information to the movement information management server 5 through the DCM 31.

The probe information transmitted from the vehicle 3 to the movement information management server 5 may not include time information corresponding to various kinds of vehicle information. In this case, the movement information management server 5 may add the time at which vehicle movement information is transmitted from the vehicle 3, the time at which the movement information management server 5 receives the vehicle movement information, an estimated time which is calculated from the above-described time and at which it is estimated that the vehicle 3 was present at the actual position corresponding to the position information, and the like to the probe information received from the vehicle 3 as time information corresponding to the various kinds of vehicle information.

The GPS module 33 receives GPS signals transmitted from three or more satellites, desirably four or more satellites above the vehicle 3, and measures the position of the vehicle 3 in which the GPS module 33 is mounted. The GPS module 33 is communicably connected to the master ECU 32 and the like through a one-to-one communication line or an in-vehicle network, such as the CAN. The measured position information of the vehicle 3 is input to the master ECU 32 and the like.

The vehicle speed sensor 34 is known detection means for detecting the vehicle speed of the vehicle 3. The vehicle speed sensor 34 is communicably connected to the master ECU 32 and the like through a one-to-one communication line or an in-vehicle network, such as the CAN. The vehicle speed information of the vehicle 3 is input to the master ECU 32.

The automatic driving ECU 35 performs control processing relevant to the automatic driving function of the vehicle 3. Specifically, the automatic driving ECU 35 controls a driving device, a brake device, a steering device, and the like of the vehicle 3 in accordance with the operation of an occupant, such as a driver, to realize a predetermined automatic driving function. The automatic driving ECU 35 periodically transmits automatic driving information to the master ECU 32 through an in-vehicle network, such as the CAN.

The digital signage apparatus 4 (an example of a digital signage) is installed around a predetermined road, and displays advertisement information (advertisement image), which is distributed from the advertisement management server 6, on a display unit (for example, a liquid crystal display) of the digital signage apparatus 4 through the predetermined communication network NW2. As described above, the advertisement information displayed on the digital signage apparatus 4 can be visually recognized by the vehicle 3 traveling on the road, a pedestrian walking on the road, and the like.

The movement information management server 5 collects and stores probe information from the vehicles 3. The movement information management server 5 includes a communication apparatus 51 and the processing apparatus 52.

The communication apparatus 51 is an apparatus that performs bidirectional communication with the vehicles 3, the advertisement management server 6, and the like through the predetermined communication networks NW1 and NW3 under the control of the processing apparatus 52 (specifically, a communication processing unit 521).

The processing apparatus 52 executes various kinds of control processing in the movement information management server 5. For example, the processing apparatus 52 is mainly formed of one or a plurality of server computers including a CPU, a RAM, a ROM, an auxiliary storage device, and an I/O interface. Hereinafter, the same applies to the processing apparatus 62 of the advertisement management server 6. The processing apparatus 52 includes the communication processing unit 521, a probe information storage processing unit 522, a vehicle search unit 523, and a vehicle information extraction unit 524 as functional units realized by executing one or more programs stored in the ROM or the auxiliary storage device on the CPU. The processing apparatus 52 includes a storage unit 529 as a storage region defined in an auxiliary storage device of a server computer or an external storage device connected to the server computer. The storage unit 529 includes a map information database (DB) 5291, a vehicle attribute information DB 5292, and a probe information DB 5293.

The communication processing unit 521 controls the communication apparatus 51 to transmit and receive various signals (a control signal, an information signal, and the like) to and from the vehicles 3 and the advertisement management server 6.

The probe information storage processing unit 522 performs processing for storing probe information, which is sequentially received from the vehicles 3 by the communication processing unit 521, in the storage unit 529 as the probe information DB 5293. In this case, the probe information storage processing unit 522 may process the probe information. For example, the probe information storage processing unit 522 may construct the probe information DB 5293 by generating information regarding the movement history (trip information) for each period from the activation to the stop of each vehicle 3, that is, each trip, based on the time-series data of the position information of the vehicles 3. The probe information of the vehicle 3 stored in the probe information DB 5293 is stored so as to be associated with identification information of the corresponding vehicle 3, for example, a vehicle index number (VIN) or a predetermined vehicle identifier (ID).

The above processing of the probe information storage processing unit 522 may be executed in real time corresponding to the probe information sequentially received from the vehicles 3 by the communication processing unit 521, or may be periodically executed on unprocessed probe information buffered to some extent.

The vehicle search unit 523 searches for the vehicle 3 that meets conditions, among the vehicles 3, in response to an inquiry (search request) from the advertisement management server 6 that is received by the communication processing unit 521, and transmits the search result to the advertisement management server 6 through the communication processing unit 521. Specifically, the vehicle search unit 523 searches for the vehicle 3, which is located in a predetermined range (visually recognizable range) on an adjacent road where the occupant can visually recognize the digital signage apparatus 4, based on information regarding the digital signage apparatus 4 (information of the digital signage) to which an advertisement is to be distributed by the advertisement management server 6 and the map information DB 5291 and the probe information DB 5293, which are included in the search request. The digital signage information includes, for example, position information of the digital signage apparatus 4, information regarding the height at which a display unit is disposed, and information regarding the positional relationship (distance, direction of the display unit, and the like) between the adjacent road and the digital signage apparatus 4.

The visually recognizable range of the digital signage apparatus 4 is an appropriate value that is appropriately set based on, for example, the positional relationship between the digital signage apparatus 4 and the adjacent road, the height at which the display unit of the digital signage apparatus 4 is installed, and a direction in which the vehicle 3 moves.

The vehicle information extraction unit 524 extracts desired vehicle information from the vehicle attribute information DB 5292 and the probe information DB 5293 in response to an inquiry (vehicle information request) from the advertisement management server 6 that is received by the communication processing unit 521, and transmits the extraction result to the advertisement management server 6 through the communication processing unit 521. The vehicle attribute information DB 5292 stores, for example, information regarding the type of the vehicle or attribute information of each of the vehicles 3, such as an automatic driving level corresponding to the mounted automatic driving function, that is, static or quasi-static vehicle information that hardly changes.

The vehicle information extraction unit 524 may extract vehicle information, which is defined in advance, according to the search result of the vehicle search unit 523 without waiting for an inquiry. In this case, transmission of the vehicle information request from the advertisement management server 6 to the movement information management server 5 is omitted.

The advertisement management server 6 (an example of a digital signage control device) performs processing relevant to advertisement distribution. The advertisement management server 6 includes a communication apparatus 61 and the processing apparatus 62.

The communication apparatus 61 is an apparatus that performs bidirectional communication with the digital signage apparatuses 4, the movement information management server 5, and the like through the predetermined communication networks NW2 and NW3 under the control of the processing apparatus 62 (specifically, a communication processing unit 621).

The processing apparatus 62 executes various kinds of control processing in the advertisement management server 6. The processing apparatus 62 includes the communication processing unit 621, a target digital signage information acquisition unit 622, a target vehicle detector 623, a work load information acquisition unit 624, and an advertisement distribution unit 625 as functional units realized by executing one or more programs stored in the ROM, the auxiliary storage device, or the like on the CPU. The processing apparatus 62 includes a storage unit 629 as a storage region defined in an auxiliary storage device, an external storage device connected to the server computer, or the like. The storage unit 629 includes an advertisement DB 6291 and a digital signage information DB 6292.

The communication processing unit 621 controls the communication apparatus 61 to transmit and receive various signals (an information signal, a control signal, and the like) to and from the digital signage apparatuses 4, the movement information management server 5, and the like.

The target digital signage information acquisition unit 622 acquires information regarding the digital signage apparatus 4 to which a predetermined advertisement, which is input through a network, such as an Internet network, or an input device of a server computer, is to be distributed from the digital signage information DB 6292. Specifically, the target digital signage information acquisition unit 622 acquires the position information of the digital signage apparatus 4 to which a predetermined advertisement is to be distributed, information regarding the height at which a display unit is disposed, information regarding the positional relationship with an adjacent road, and the like from the digital signage information DB 6292.

In the advertisement DB 6291, in addition to advertisement data (for example, an advertisement image) corresponding to the content of the input advertisement, information (guide destination information) regarding a guide destination (for example, a real store selling a product to be advertised) to which the user needs to be guided by the advertisement, characteristic information (user characteristic target information) of a target user as a target of the advertisement, information (location target information) regarding a location (for example, a point of interest (POI) as a target of the advertisement where a large number of target users gather, an area close to the guide destination to guide the user, and a road link that the user heading for the guide destination may pass), and the like are stored so as to be linked to the advertisement data. The digital signage apparatus 4 to which a predetermined advertisement is to be distributed may be determined in consideration of the target information described above.

The target vehicle detector 623 detects the vehicle 3 located in the visually recognizable range of the digital signage apparatus 4 to which a predetermined advertisement is to be distributed, among the vehicles 3, by asking the movement information management server 5. Specifically, the target vehicle detector 623 transmits a search request, which includes the information of the digital signage acquired by the target digital signage information acquisition unit 622, to the movement information management server 5 through the communication processing unit 621. As described above, the vehicle search unit 523 of the movement information management server 5 searches for the vehicle 3 located in the visually recognizable range of the digital signage apparatus 4 to which a predetermined advertisement is to be distributed, and transmits the identification information of the vehicle 3 found by the search as the search result. Therefore, the target vehicle detector 623 can detect the vehicle 3, which is located in the visually recognizable range of the digital signage apparatus 4 to which a predetermined advertisement is to be distributed, based on the transmitted search result.

In another method, the target vehicle detector 623 may detect the vehicle 3 located in the visually recognizable range of the digital signage apparatus 4. For example, a sensor for detecting the vehicle 3, such as a camera, may be mounted in the digital signage apparatus 4, and the target vehicle detector 623 may detect a vehicle 3 located in the visually recognizable range of the digital signage apparatus 4 based on the output information of the sensor. Specifically, specific detection processing may be performed by the digital signage apparatus 4, and the detection result may be transmitted from the digital signage apparatus 4 to the advertisement management server 6. As described above, the target vehicle detector 623 can detect the vehicle 3 located in the visually recognizable range of the digital signage apparatus 4 according to the detection result from the digital signage apparatus 4 that is received by the communication processing unit 621.

The work load information acquisition unit 624 acquires information (work load information) regarding the work load of the occupant of the vehicle 3 detected by the target vehicle detector 623 by asking the movement information management server 5. The work load of the occupant of the vehicle 3 includes, for example, a work load (driving load) relevant to the driving operation of the driver of the vehicle 3. The work load of the occupant of the vehicle 3 includes a work load (visual recognition work load) for visual recognition of the digital signage apparatus 4 by the occupant of the vehicle 3. Specifically, the work load information acquisition unit 624 transmits a vehicle information request, which includes vehicle information requested as work load information, to the movement information management server 5 through the communication processing unit 621. As described above, the vehicle information extraction unit 524 of the movement information management server 5 extracts requested vehicle information, and transmits the extracted vehicle information as the extraction result. Therefore, the work load information acquisition unit 624 can acquire desired vehicle information corresponding to the work load information from the transmitted extraction result. Details of the work load information acquired by the work load information acquisition unit 624 will be described later.

In the work load of the occupant of the vehicle 3, in addition to the driving load or the visual recognition work load described above, other work loads, that is, work loads relevant to operations (for example, reading, browsing of Internet information using a smartphone, and conversation between occupants) other than the driving operation or the visual recognition of the digital signage apparatus 4 performed by the occupant of the vehicle 3 may be included. In this case, the work loads relevant to operations other than the driving operation or the visual recognition of the digital signage apparatus 4 can be determined based on, for example, a captured image obtained by using a camera that is mounted in the vehicle 3 to capture the inside of the vehicle cabin or recorded data obtained by using a microphone for acquiring sound in the vehicle cabin. That is, the probe information transmitted from each of the vehicles 3 to the movement information management server 5 may include a captured image obtained by using a camera for capturing the inside of the vehicle cabin, recorded data obtained by using a microphone inside the vehicle cabin, meta information regarding the work load generated from the captured image or the recorded data, and the like.

The advertisement distribution unit 625 (an example of a display controller) transmits advertisement data to the digital signage apparatus 4, to which the advertisement is to be distributed, through the communication processing unit 621. As described above, the advertisement distribution unit 625 can display advertisement information (advertisement image) corresponding to the advertisement data on the display unit of the digital signage apparatus 4. The advertisement distribution unit 625 changes the amount of advertisement information (information amount) displayed on the digital signage apparatus 4 according to the work load information (predetermined vehicle information) of the occupant of the vehicle 3 located in the visually recognizable range of the digital signage apparatus 4 that has been acquired by the work load information acquisition unit 624. Specifically, the advertisement distribution unit 625 changes the amount of advertisement information displayed on the digital signage apparatus 4 by transmitting a command signal through the communication processing unit 621. For example, the advertisement distribution unit 625 determines the work load state of the occupant of the vehicle 3 located in the visually recognizable range of the digital signage apparatus 4 based on the work load information acquired by the work load information acquisition unit 624. In a case where the work load of the occupant of the vehicle 3 is relatively high, the advertisement distribution unit 625 sets the amount of advertisement information displayed on the digital signage apparatus 4 to be less than that in a case where the work load of the occupant is relatively low. In this case, for example, the advertisement distribution unit 625 distributes advertisement information of complete specifications and advertisement information of one or more simple specifications, which includes merely some of a plurality of pieces of detailed information configuring the advertisement information of complete specifications, as advertisement data, to the digital signage apparatus 4 through the communication processing unit 621 in advance. As described above, in a situation in which the work load of the occupant of the vehicle 3 is relatively high, the amount of information graspable by the occupant of the vehicle 3 can be limited. As a result, since the amount of advertisement information is changed to be reduced, the occupant of the vehicle 3 can grasp the advertisement information displayed on the digital signage apparatus 4 even in the above-described situation.

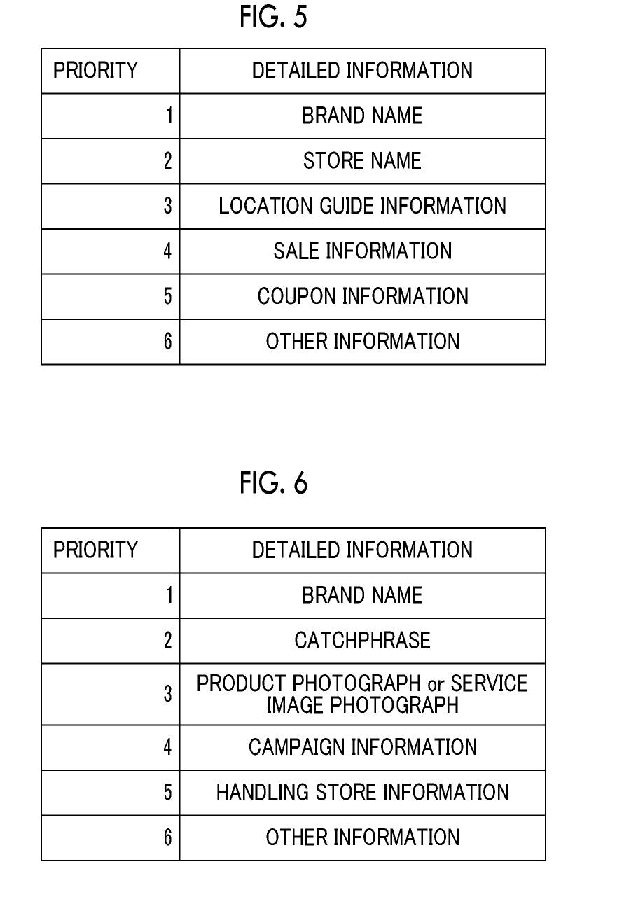

For example, FIGS. 5 and 6 are diagrams showing examples of a plurality of pieces of detailed information that can be included in advertisement information. Specifically, FIG. 5 is a diagram showing a specific example of a plurality of pieces of detailed information that can be included in advertisement information relevant to a specific store. FIG. 6 is a diagram showing a specific example of a plurality of pieces of detailed information that can be included in advertisement information relevant to a product or a service.

As shown in FIG. 5, as detailed information that can be included in advertisement information relevant to a specific store, six items of brand name of specific store, store name, location guide information, sale information, coupon information, and other information other than the above are defined. For each piece of the detailed information, a priority is defined in the range of level 1 to level 6. In order of brand name, store name, location guide information, sale information, coupon information, and other information, “level 1”, “level 2”, “level 3”, “level 4”, “level 5”, and “level 6” are assigned from the highest priority.

As shown in FIG. 6, as detailed information that can be included in advertisement information relevant to a specific product or service (hereinafter, referred to as a product or the like), six items of brand name of specific product or the like, catchphrase, product photograph or service image photograph, campaign information, handling store information, and other information other than the above are defined. Similar to the case of a store, for each piece of the detailed information, a priority is defined in the range of level 1 to level 6. In order of brand name, catchphrase, product photograph or service image photograph, campaign information, handling store information, and other information, “level 1”, “level 2”, “level 3”, “level 4”, “level 5”, and “level 6” are assigned from the highest priority.

For example, in a case where the advertisement distribution unit 625 reduces the amount of advertisement information relatively, that is, in a case where the advertisement information on simple specification is generated, detailed information having a relatively higher priority than detailed information having a relatively low priority may be included in the advertisement information. As described above, by giving a relatively high priority in advance to detailed information indispensable as advertisement information or detailed information having a relatively high contribution to the effect of the advertisement, it is possible to display appropriate advertisement information on the digital signage apparatus 4 even in a case where the amount of advertisement information is relatively reduced.

According to a command signal from the advertisement distribution unit 625, processing for changing the amount of advertisement information (image processing) may be performed by the digital signage apparatus 4.

### Details of Operation of Advertisement Distribution System

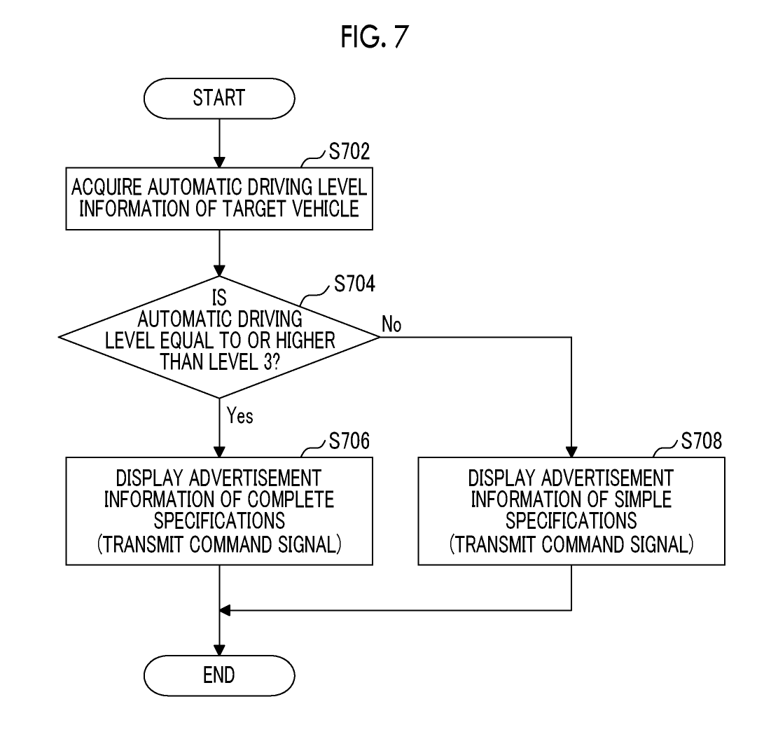

A specific operation of the advertisement distribution system 1 will be described with reference to FIGS. 7 to 10.

First, FIG. 7 is a flowchart schematically showing a first example of a process for changing the amount of advertisement information (information amount change processing) by the advertisement management server 6 (processing apparatus 62) according to the present embodiment.

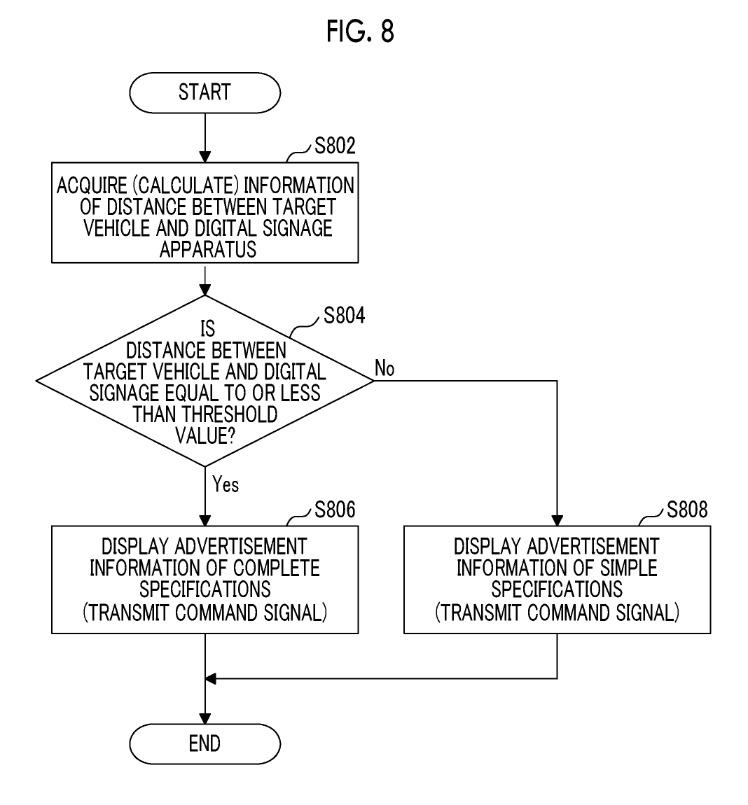

The process according to this flowchart is executed for each digital signage apparatus 4 to which a predetermined advertisement is to be distributed among the digital signage apparatuses 4. The process according to this flowchart is started in a case where the vehicle 3 is detected in the visually recognizable range of the digital signage apparatus 4, to which a predetermined advertisement is to be distributed, by the target vehicle detector 623, and is repeatedly executed until the vehicle 3 is no longer detected. In a case where the vehicles 3 are detected by the target vehicle detector 623, the process according to the flowchart may be executed for the vehicle 3 closest to the digital signage apparatus 4 among the detected vehicles 3. Hereinafter, the same applies to the flowcharts shown in FIGS. 8 to 10.

In step S702, the work load information acquisition unit 624 acquires information regarding the driving load (driving load information) of the driver of the target vehicle 3 as work load information by transmitting a vehicle information request to the movement information management server 5 through the communication processing unit 621. Specifically, the work load information acquisition unit 624 acquires information regarding the automatic driving level of the automatic driving function being operated in the target vehicle 3 as the driving load information.

In step S704, the advertisement distribution unit 625 determines whether or not the automatic driving level of the automatic driving function being operated in the target vehicle 3, which has been acquired by the work load information acquisition unit 624, is equal to or higher than the automatic driving level 3. The advertisement distribution unit 625 proceeds to step S706 in a case where the automatic driving level of the automatic driving function being operated in the target vehicle 3 is equal to or higher than the automatic driving level 3, and proceeds to step S708 in a case where the automatic driving level of the automatic driving function being operated in the target vehicle 3 is not equal to or higher than the automatic driving level 3.

Even in a case where the target vehicle 3 has the automatic driving function, the automatic driving level is determined to be “0” in a state where the automatic driving function is not operating.

In step S706, the advertisement distribution unit 625 transmits a command signal, which is for displaying the advertisement information of complete specifications, to the digital signage apparatus 4 through the communication processing unit 621, and ends the current process.

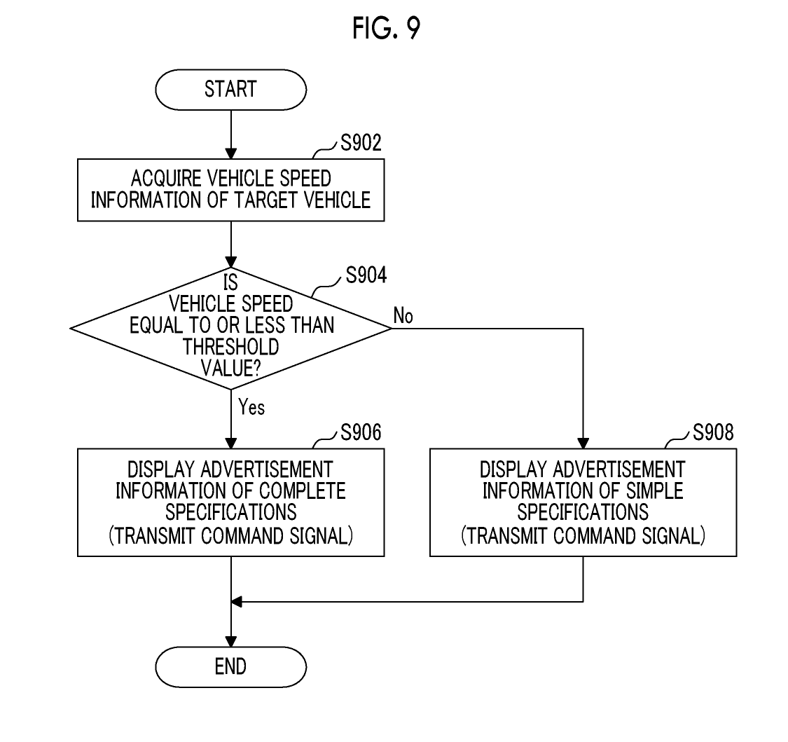

On the other hand, in step S708, the advertisement distribution unit 625 transmits a command signal, which is for displaying the advertisement information of simple specifications defined in advance, to the digital signage apparatus 4 through the communication processing unit 621, and ends the current process. The advertisement information of simple specifications may be, for example, advertisement information including merely detailed information having priorities of level 1 to level 3 among the plurality of pieces of detailed information shown in FIGS. 5 and 6. Hereinafter, the same applies to the processes shown in FIGS. 8 and 9. As described above, in a situation in which the automatic driving level of the automatic driving function being operated is lower than the automatic driving level threshold value and the driving load of the driver is higher than the driving load threshold value, that is, a situation in which it is difficult for the driver to grasp the advertisement information of the digital signage apparatus 4, the amount of advertisement information displayed on the digital signage apparatus 4 is relatively reduced. Therefore, even in the above-described situation, the driver of the vehicle 3 can more reliably grasp the content of the information displayed on the digital signage apparatus 4.

In this example, as the information regarding the driving load of the driver of the vehicle 3, the automatic driving level of the automatic driving function being operated in the vehicle 3 is adopted. However, other information can be undoubtedly adopted. For example, information regarding the congestion situation of the road on which the vehicle 3 is traveling, the presence or absence of congestion, and the like may be included in the information regarding the driving load. It is thought that this is because, in a case where the road is relatively crowded, the distance to other vehicles is shorter than in a case where the road is not relatively crowded, and accordingly the driving load is relatively high.

FIG. 8 is a flowchart schematically showing a second example of the information amount change processing of the advertisement management server 6 (processing apparatus 62) according to the present embodiment.

In step S802, the work load information acquisition unit 624 acquires information regarding the visual recognition work load (visual recognition work load information) of the occupant of the target vehicle 3, which is for visually recognizing the advertisement information of the digital signage apparatus 4, as work load information by transmitting a vehicle information request to the movement information management server 5 through the communication processing unit 621. Specifically, the work load information acquisition unit 624 acquires information regarding the distance between the target vehicle 3 and the digital signage apparatus 4 as the visual recognition work load information. More specifically, the work load information acquisition unit 624 acquires the position information of the target vehicle 3 from the movement information management server 5 through the communication processing unit 621, and acquires the position information of the digital signage apparatus 4, to which a predetermined advertisement is to be distributed, from the digital signage information DB 6292. The work load information acquisition unit 624 calculates the distance between the target vehicle 3 and the digital signage apparatus 4 based on the position information of the target vehicle 3 and the position information of the digital signage apparatus 4.

In step S804, the advertisement distribution unit 625 determines whether or not the distance between the target vehicle 3 and the digital signage apparatus 4 is equal to or less than a predetermined threshold value. The advertisement distribution unit 625 proceeds to step S806 in a case where the distance between the target vehicle 3 and the digital signage apparatus 4 is equal to or less than the predetermined threshold value, and proceeds to step S808 in a case where the distance between the target vehicle 3 and the digital signage apparatus 4 is not equal to or less than the predetermined threshold value.

In step S806, the advertisement distribution unit 625 transmits a command signal, which is for displaying the advertisement information of complete specifications, to the digital signage apparatus 4 through the communication processing unit 621, and ends the current process.

On the other hand, in step S808, the advertisement distribution unit 625 transmits a command signal, which is for displaying the advertisement information of simple specifications defined in advance, to the digital signage apparatus 4 through the communication processing unit 621, and ends the current process. As described above, in a situation in which the distance between the vehicle 3 and the digital signage apparatus 4 is relatively long and accordingly the visual recognition work load for the occupant of the vehicle 3 to visually recognize the digital signage apparatus 4 is higher than the visual recognition work load threshold value, the amount of displayed advertisement information is relatively reduced. Therefore, even in the above-described situation, the driver of the vehicle 3 can more reliably grasp the content of the information displayed on the digital signage apparatus 4.

In this example, as the information regarding the visual recognition work load for the occupant of the vehicle 3 to visually recognize the advertisement information of the digital signage apparatus 4, the distance between the vehicle 3 and the digital signage apparatus 4 is adopted. However, other information can be undoubtedly adopted. For example, information regarding the radius of curvature of the road adjacent to the digital signage apparatus 4 may be included in the information regarding the visual recognition work load of the occupant of the vehicle 3. It is thought that this is because, in a case where the road adjacent to the digital signage apparatus 4 is a curved road, a change in the appearance of the digital signage apparatus 4 from the occupant of the vehicle 3 due to the travel of the vehicle 3 is larger than that in a case where the road adjacent to the digital signage apparatus 4 is a straight road, and accordingly the visual recognition work load of the occupant of the vehicle 3 is relatively increased.

FIG. 9 is a flowchart schematically showing a third example of the information amount change processing of the advertisement management server 6 (processing apparatus 62) according to the present embodiment.

In step S902, the work load information acquisition unit 624 acquires the vehicle speed information of the target vehicle 3, which corresponds to both the driving load information and the visual recognition work load information, as work load information by transmitting a vehicle information request to the movement information management server 5 through the communication processing unit 621.

In step S904, the advertisement distribution unit 625 determines whether or not the vehicle speed of the target vehicle 3 is equal to or lower than a predetermined speed. The advertisement distribution unit 625 proceeds to step S906 in a case where the vehicle speed of the target vehicle 3 is equal to or lower than the predetermined speed, and proceeds to step S908 in a case where the vehicle speed of the target vehicle 3 is not equal to or lower than a predetermined speed.

In step S906, the advertisement distribution unit 625 transmits a command signal, which is for displaying the advertisement information of complete specifications, to the digital signage apparatus 4 through the communication processing unit 621, and ends the current process.

On the other hand, in step S908, the advertisement distribution unit 625 transmits a command signal, which is for displaying the advertisement information of simple specifications defined in advance, to the digital signage apparatus 4 through the communication processing unit 621, and ends the current process. As described above, in a case where the vehicle speed becomes higher than the vehicle speed threshold value, it is demanded to accelerate various determinations in the driving operation, and the driving load becomes higher than the driving load threshold value. In addition, a higher dynamic vision for checking the information of the digital signage apparatus 4 is demanded, and the visual recognition work load becomes higher than the visual recognition work load threshold value. As a result, in the above-described situation, the amount of displayed information is relatively reduced. Therefore, even in the above-described situation, the driver of the vehicle 3 can more reliably grasp the content of the information displayed on the digital signage apparatus 4.

In this example, as the information corresponding to both the information regarding the driving load and the information regarding the visual recognition work load, the vehicle speed information of the vehicle 3 is adopted. However, other information can be undoubtedly adopted. For example, information regarding a steering operation, specifically, steering angle information from a steering angle sensor (not shown) of the vehicle 3 may be included as the information corresponding to both the information regarding the driving load and the information regarding the visual recognition work load. This is because the driving load of the driver can change depending on the presence or absence of the steering operation and the magnitude of the steering angle. As in the case where the road adjacent to the digital signage apparatus 4 is a curved road, it is thought that this is because a change in the appearance of the digital signage apparatus 4 from the occupant of the vehicle 3 due to the travel of the vehicle 3 increases as the steering angle increases, and accordingly the visual recognition work load of the occupant of the vehicle 3 is relatively increased. In this case, the probe information uploaded from the vehicle 3 to the movement information management server 5 may include the steering angle information from the steering angle sensor of the vehicle 3.

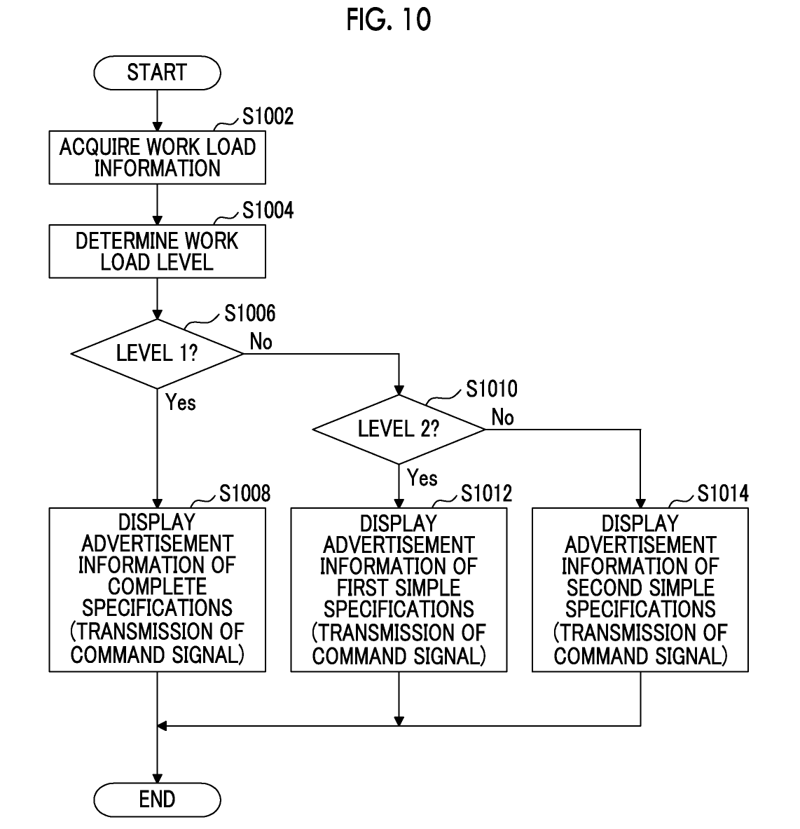

FIG. 10 is a flowchart schematically showing a fourth example of the information amount change processing of the advertisement management server 6 (processing apparatus 62) according to the present embodiment.

In step S1002, the work load information acquisition unit 624 acquires a plurality of types of information as work load information by transmitting a vehicle information request to the movement information management server 5 through the communication processing unit 621. For example, the work load information acquisition unit 624 acquires information regarding the automatic driving level of the automatic driving function being operated in the target vehicle 3, information regarding the distance between the target vehicle 3 and the digital signage apparatus 4, and information regarding the vehicle speed of the target vehicle 3.

In step S1004, the advertisement distribution unit 625 determines work load levels of a plurality of stages, which indicate the level of the work load of the occupant of the target vehicle 3, based on the types of acquired information. In this example, the advertisement distribution unit 625 determines to which level the work load of the occupant of the target vehicle 3 corresponds among three stages from the lowest work load level 1 to the highest work load level 3. For example, for each of the conditions set in advance for each of a plurality of types of information, for example, for each combination of success or failure of the determination conditions in steps S704, S804, and S904 in FIGS. 7 to 9, a map or the like predefining to which of level 1 to level 3 each condition corresponds may be defined. For example, a map or the like for calculating a score indicating the degree of influence on the work load for each of a plurality of types of information and a map or the like of the correspondence relationship, in which the total value and the work load level (level 1 to level 3) are associated with each other in a state in which the work load of the occupant increases as the total value of the scores corresponding to the plurality of types of information increases, may be predefined. As described above, the advertisement distribution unit 625 can determine the work load level based on the map or the like.

In step S1006, the advertisement distribution unit 625 determines whether or not the work load level is the lowest level 1. The advertisement distribution unit 625 proceeds to step S1008 in a case where the work load level is level 1, and proceeds to step S1010 in a case where the work load level is not level 1.

In step S1008, the advertisement distribution unit 625 transmits a command signal, which is for displaying the advertisement information of complete specifications, to the digital signage apparatus 4 through the communication processing unit 621, and ends the current process.

On the other hand, in step S1010, the advertisement distribution unit 625 determines whether or not the work load level is level 2. The advertisement distribution unit 625 proceeds to step S1012 in a case where the work load level is level 2, and proceeds to step S1014 in a case where the work load level is not level 2, that is, in a case where the work load level is level 3.

In step S1012, the advertisement distribution unit 625 transmits a command signal, which is for displaying the advertisement information of the first simple specifications defined in advance, to the digital signage apparatus 4 through the communication processing unit 621, and ends the current process. The advertisement information of the first simple specifications may be, for example, advertisement information including merely detailed information having priorities of level 1 to level 3 among the pieces of detailed information shown in FIGS. 5 and 6.

On the other hand, in step S1014, the advertisement distribution unit 625 transmits a command signal, which is for displaying the advertisement information of the second simple specifications defined in advance, to the digital signage apparatus 4 through the communication processing unit 621, and ends the current process. The advertisement information of the second simple specifications may be advertisement information having a smaller information amount than the advertisement information of the first simple specifications. For example, the advertisement information of the second simple specifications may be advertisement information including merely detailed information having priorities of level 1 and level 2 among the pieces of detailed information shown in FIGS. 5 and 6.

In this example, by using a plurality of types of information as the work load information, it is possible to comprehensively determine the work load state of the vehicle 3. In this example, the amount of advertisement information displayed on the digital signage apparatus 4 can be changed in three stages according to the work load state of the occupant of the vehicle 3. Therefore, it is possible to more finely adjust the balance between the information amount of advertisement information and the promotion of the grasp of the advertisement information by the occupant of the vehicle 3.

### Effect

As described above, in the present embodiment, the target vehicle detector 623 detects the vehicle 3 located in the visually recognizable range of the digital signage apparatus 4, and the work load information acquisition unit 624 acquires the work load information that is the information regarding the work load state of the occupant of the vehicle 3. The advertisement distribution unit 625 changes the amount of advertisement information to be displayed on the digital signage apparatus 4 according to the work load information. As described above, for example, in a case where determination that the work load of the occupant is relatively high for some reason can be made, the advertisement distribution unit 625 can relatively reduce the amount of advertisement information displayed on the digital signage apparatus 4. Therefore, even in a situation in which it is difficult for the occupant to grasp the advertisement information displayed on the digital signage apparatus 4, the occupant of the vehicle 3 can more reliably grasp the content of the advertisement information displayed on the digital signage apparatus 4.

In the present embodiment, the work load information acquisition unit 624 acquires the work load information including at least one of the information regarding the driving load of the driver of the vehicle 3 and the information regarding the visual recognition work load for the occupant of the vehicle 3 to visually recognize the digital signage apparatus 4. As described above, the advertisement distribution unit 625 can change the amount of advertisement information displayed on the digital signage apparatus 4 by using the driving load information of the driver or the visual recognition work load information of the occupant as the work load information, specifically, according to the situation of the driving load or the visual recognition work load.

In the present embodiment, in a case where the driving load of the driver of the vehicle 3 is higher than the driving load threshold value, the work load information acquisition unit 624 sets the amount of advertisement information displayed on the digital signage apparatus 4 to be less than that in a case where the driving load is lower than the driving load threshold value. As described above, in a situation in which the driving load of the driver is higher than the driving load threshold value and accordingly it is difficult for the driver to grasp the advertisement information displayed on the digital signage apparatus 4, the amount of advertisement information displayed on the digital signage apparatus 4 is relatively reduced. Therefore, even in the above-described situation, the driver of the vehicle 3 can more reliably grasp the content of the advertisement information displayed on the digital signage apparatus 4.

In the present embodiment, information regarding the automatic driving level of the automatic driving function being operated in the vehicle 3 is included in the driving load information. In a case where the automatic driving level of the automatic driving function being operated in the vehicle 3 is lower than the automatic driving level threshold value, the advertisement distribution unit 625 sets the amount of advertisement information displayed on the digital signage apparatus 4 to be less than that in a case where the automatic driving level is higher than the automatic driving level threshold value. As described above, in a situation in which the automatic driving level of the automatic driving function being operated in the vehicle 3 is lower than the automatic driving level threshold value and accordingly the driving load of the driver is higher than the driving load threshold value and it is difficult for the driver to grasp the advertisement information displayed on the digital signage apparatus 4, the amount of displayed advertisement information is relatively reduced. Therefore, even in the above-described situation, the driver of the vehicle 3 can more reliably grasp the content of the advertisement information displayed on the digital signage apparatus 4.

In the present embodiment, in a case where the visual recognition work load of the occupant of the vehicle 3 is higher than the visual recognition work load threshold value, the advertisement distribution unit 625 sets the amount of advertisement information displayed on the digital signage apparatus 4 to be less than that in a case where the visual recognition work load is lower than the visual recognition work load threshold value. As described above, for example, in a situation in which the visual recognition work load for the occupant of the vehicle 3 to visually recognize the digital signage apparatus 4 is higher than the visual recognition work load threshold value, such as in the digital signage apparatus 4 provided on a curved road, the amount of advertisement information displayed on the digital signage apparatus 4 is relatively reduced. Therefore, even in the above-described situation, the occupant of the vehicle 3 can more reliably grasp the content of the advertisement information displayed on the digital signage apparatus 4.

In the present embodiment, the information regarding the distance between the vehicle 3 and the digital signage apparatus 4 is included in the visual recognition work load information. In a case where the distance between the vehicle 3 and the digital signage apparatus 4 is larger than the distance threshold value, the advertisement distribution unit 625 sets the amount of advertisement information displayed on the digital signage apparatus 4 to be less than that in a case where the distance is less than the distance threshold value. As described above, in a situation in which the distance between the vehicle 3 and the digital signage apparatus 4 is larger than the distance threshold value and accordingly the visual recognition work load for the occupant of the vehicle 3 to visually recognize the digital signage apparatus 4 is higher than the visual recognition work load threshold value, the amount of displayed advertisement information is relatively reduced. Therefore, even in the above-described situation, the occupant of the vehicle 3 can more reliably grasp the content of the advertisement information displayed on the digital signage apparatus 4.

In the present embodiment, the information regarding the vehicle speed of the vehicle 3 corresponding to both the driving load information and the visual recognition work load information is included in the work load information. In a case where the vehicle speed of the vehicle 3 is higher than the vehicle speed threshold value, the advertisement distribution unit 625 sets the amount of advertisement information displayed on the digital signage apparatus 4 to be less than that in a case where the vehicle speed of the vehicle 3 is lower than the vehicle speed threshold value. As described above, in a case where the vehicle speed becomes higher than the vehicle speed threshold value, it is demanded to accelerate various determinations in the driving operation, and the driving load becomes higher than the driving load threshold value. In addition, a higher dynamic vision for checking the information of the digital signage apparatus 4 is demanded, and the visual recognition work load becomes high. As a result, in the above-described situation, the amount of displayed information is relatively reduced. Therefore, even in the above-described situation, occupants including the driver of the vehicle 3 can more reliably grasp the content of the information displayed on the digital signage apparatus 4.

In the present embodiment, the advertisement distribution unit 625 changes the amount of advertisement information displayed on the digital signage apparatus 4 by changing the number of pieces of detailed information actually included in the content of the advertisement information among a plurality of pieces of detailed information that can be included as the content of the advertisement information. Therefore, for example, in the case of displaying the advertisement information of a product on the digital signage apparatus 4, the advertisement distribution unit 625 can change the amount of information by changing a combination of a plurality of pieces of detailed information, such as a brand name of a product, a catchphrase, and a product photograph that can configure advertisement information.

In the present embodiment, the advertisement distribution unit 625 determines detailed information actually included in the content of advertisement information, among a plurality of pieces of detailed information, according to the priority defined in advance for each of the pieces of detailed information. As described above, by adopting a method in which detailed information having a relatively high priority is included in advertisement information that is preferentially displayed according to the priority defined in advance, the advertisement distribution unit 625 can change the amount of advertisement information. For example, by giving a relatively high priority in advance to detailed information having a relatively high contribution to grasping the advertisement information displayed on the digital signage apparatus 4 by the occupant of the vehicle 3, the occupant of the vehicle 3 can more reliably grasp the content of the advertisement information displayed on the digital signage apparatus 4.

While the embodiments of the invention have been described in detail above, the invention is not limited to the specific embodiments described above, and various modifications and changes can be made within the scope of the invention described in the claims.

For example, in the embodiment described above, the functions of the movement information management server 5 and the advertisement management server 6 may be realized by one server.

In the embodiment described above, the functions of the movement information management server 5 and the advertisement management server 6 may be shared by other servers that can communicate with both the movement information management server 5 and the advertisement management server 6.

In the embodiment described above, the digital signage apparatus 4 may be made to have some or all of the functions of the target vehicle detector 623 and the work load information acquisition unit 624 and the function of a portion corresponding to the information amount change processing in the advertisement distribution unit 625.

In the embodiment described above, the advertisement information is displayed on the digital signage apparatus 4. However, information other than the advertisement information may be displayed. For example, information regarding a public event or the like of an area where the digital signage apparatus 4 is installed may be displayed on the digital signage apparatus 4. Also in this case, by changing the amount of information displayed on the digital signage apparatus 4 according to the work load state of the target vehicle 3 as in the embodiment described above, the same effect is obtained.

In the embodiment described above, in the case of changing the amount of advertisement information displayed on the digital signage apparatus 4, the content of the advertisement information, that is, an advertisement target, such as a store, a product, and a service, is not changed. However, the advertisement target may be changed. For example, a plurality of pieces of advertisement information having different amounts of advertisement information, that is, different information amounts of advertisement information and different advertisement targets may be prepared in advance, and which of the pieces of advertisement information is to be displayed may be switched according to the work load information. Also in this case, by changing the amount of information displayed on the digital signage apparatus 4 according to the work load state of the target vehicle 3 as in the embodiment described above, the same effect is obtained.

What is claimed is:

1. A digital signage control device comprising circuitry configured to:
display predetermined information on a digital signage disposed around a predetermined road;
detect a vehicle located in a predetermined range on the road, the predetermined range on the road being a range in which an occupant of the vehicle visually recognizes the digital signage; and
acquire work load information regarding a work load state of the occupant of the vehicle,
wherein the circuitry is configured to change an amount of the predetermined information to be displayed on the digital signage according to the work load information.

2. The digital signage control device according to claim 1, wherein the circuitry is configured to acquire the work load information including at least one of information regarding a driving load of a driver of the vehicle and information regarding a visual recognition work load for the occupant of the vehicle to visually recognize the digital signage.

3. The digital signage control device according to claim 2, wherein the circuitry is configured to set, when the driving load is higher than a driving load threshold value, the amount of the predetermined information displayed on the digital signage to be less than the amount of the predetermined information displayed on the digital signage when the driving load is lower than the driving load threshold value.

4. The digital signage control device according to claim 3, wherein:
the information regarding the driving load includes information regarding an automatic driving level of the vehicle; and
the circuitry is configured to set, when the automatic driving level is lower than an automatic driving level threshold value, the amount of the predetermined information displayed on the digital signage to be less than the amount of the predetermined information displayed on the digital signage when the automatic driving level is higher than the automatic driving level threshold value.

5. The digital signage control device according to claim 2, wherein the circuitry is configured to set, when the visual recognition work load is higher than a visual recognition work load threshold value, the amount of the predetermined information displayed on the digital signage to be less than the amount of the predetermined information displayed on the digital signage when the visual recognition work load is lower than the visual recognition work load threshold value.

6. The digital signage control device according to claim 5, wherein:
the information regarding the visual recognition work load includes information regarding a distance between the vehicle and the digital signage; and
the circuitry is configured to set, when the distance is longer than a distance threshold value, the amount of the predetermined information displayed on the digital signage to be less than the amount of the predetermined information displayed on the digital signage when the distance is shorter than the distance threshold value.

7. The digital signage control device according to claim 2, wherein:
the information regarding the driving load and the information regarding the visual recognition work load include information regarding a vehicle speed of the vehicle; and
the circuitry is configured to set, when the vehicle speed is higher than a vehicle speed threshold value, the amount of the predetermined information displayed on the digital signage to be less than the amount of the predetermined information displayed on the digital signage when the vehicle speed is lower than the vehicle speed threshold value.

8. The digital signage control device according to claim 1, wherein the circuitry is configured to change the amount of the predetermined information displayed on the digital signage by changing the number of pieces of detailed information actually included in a content of the predetermined information among a plurality of pieces of detailed information included as the content of the predetermined information.

9. The digital signage control device according to claim 8, wherein the circuitry is configured to determine detailed information actually included in the content of the predetermined information, among the pieces of detailed information, according to a priority defined in advance for each of the plurality of pieces of detailed information.

10. A digital signage control method comprising:
displaying predetermined information on a digital signage disposed around a predetermined road;
detecting a vehicle located in a predetermined range on the road, the predetermined range on the road being range in which an occupant of the vehicle visually recognizes the digital signage; and
acquiring work load information regarding a work load state of the occupant of the vehicle,
wherein the displaying of the predetermined information includes changing an amount of the predetermined information to be displayed on the digital signage according to the work load information.

11. A non-transitory storage medium storing a program causing a computer to execute
a display control step of displaying predetermined information on a digital signage disposed around a predetermined road;
a target vehicle detection step of detecting a vehicle located in a predetermined range on the road, the predetermined range on the road being a range in which an occupant of the vehicle visually recognizes the digital signage; and
a work load information acquisition step of acquiring work load information regarding a work load state of the occupant of the vehicle,
wherein, in the display control step, an amount of the predetermined information to be displayed on the digital signage is changed according to the work load information.
